(19) United States
(12) Patent Application Publication
(10) Pub. No.: US 2019/0300098 A1
(43) Pub. Date: Oct. 3, 2019

(54) BICYCLE REAR SUSPENSION SYSTEM

(71) Applicant: Don Thuren, Bend, OR (US)

(72) Inventor: Don Thuren, Bend, OR (US)

(21) Appl. No.: 15/944,241

(22) Filed: Apr. 3, 2018

(51) Int. Cl. B62K 25/30; B62K 25/28

(52) U.S. Cl. CPC B62K 25/30; B62K 25/286

(57) ABSTRACT

Embodiments described herein provide for bicycle having a rear suspension system having a shock absorber connecting a bicycle frame with a single-pivot swing arm. The swing arm pivot point and rear wheel axle are positioned on a linear axis above the bottom shock mount reducing the leverage and restricting the generated forces to a single direction.

### FIELD

The present embodiments relate to a bicycle suspension system commonly implemented on a mountain bike, and specifically relates to a linkage-less rear suspension system for a bicycle.

### BACKGROUND

A variety of rear wheel suspension systems are used on bicycles to improve performance, especially on unstable and varying surface conditions. Many of these suspension systems include a variety of complicated components and structures incorporated into the frame member to control the motion of the swingarm and the rear wheel engaged therewith.

In the current art, linkage-less suspension utilizing a single pivot design have an angular arm to position the shock well above the swing arms pivot point. This orientation decreases the leverage ratio in the available space without the need for leverage-reducing linkage members. These existing techniques create extra side loads and forces through the main frame in a number of different directions.

U.S. Pat. No. 6,361,059 is directed towards a bicycle with a rear wheel suspension having a single pivot axis that is located proximate the bottom bracket of the bicycle frame. A top portion of the swingarm, proximate the seat stays, is engaged to a shock absorber which controls the motion of the rear wheel swingarm.

U.S. Pat. No. 8,641,072 to Santa Cruz Bicycles Inc. describes a bicycle frame and a rear wheel suspension system attached to the frame. The rear wheel system has a swingarm and a shock absorber coupled thereto.

U.S. Pat. No. 6,164,676 to Trek Bicycle Corporation discloses a variable reduction cross-linkage for a rear suspension bicycle including a four-bar linkage comprised of a portion of the frame between a first pivot point and a second pivot point. Further, a portion of the rear swing arm, as well as a long link and a short link. The swing arm pivots about the first pivot point relative to the frame while the long link is pivotable relative to the frame about the second pivot point. A shock absorber is pivotally attached to the frame and long link.

U.S. Pat. No. 6,513,823 to Far Great Plastics Industrial Co. discloses a shock absorber stopper for a bicycle comprising a seat pipe connected to a seat and a bottom portion connecting to a connecting device for pivoting the top end of a shock absorber by a quick-release connector. A rear fork is coupled to a bracket on the rear end of a crossbar of a frame including the seat pipe to receive a rear wheel thereat.

The linkage suspension systems and altered configurations in the noted prior art permit further advances in preferentially positioned linkage-less single pivot suspension. Once such advantage is described in the embodiments herein.

### SUMMARY OF THE INVENTION

Embodiments described herein provide for a bicycle having a linkage-less single pivot rear suspension system. In at least one aspect of the present invention, the system comprises a shock absorber having a top end and a bottom end. The top end is pivotally connected to a top shock mount, and wherein the bottom end is pivotally connected to a bottom shock mount. The system also has a bicycle having a frame, wherein both the top shock mount is disposed on a frame of a bicycle. The bottom shock mount is disposed on a swingarm of the bicycle and the swingarm is pivotally mounted to the frame.

In an embodiment, the frame further comprises a top portion, a front portion, and a rear portion.

In another embodiment, the swingarm is pivotally mounted to the frame via a swingarm pivot. The top shock is mounted on the rear portion of the frame via the swingarm pivot while the top shock mount is pivotally mounted to the frame on the rear portion thereof.

The swingarm is further comprised of a rear wheel aperture configured to receive a plurality of rear wheel components. The rear wheel aperture and swing arm pivot are positioned above the bottom shock mount such that leverage is decreased during shock absorption.

The frame may further comprise a headtube to receive handlebars and a steering fork assembly for controlling the operation of the bicycle during use.

In another aspect of the present invention, a bicycle having a rear suspension system has a frame member having a front portion, a rear portion, and a top portion. The rear portion has a top shock mount. A swing arm is pivotally connected to the frame while a bottom shock mount is positioned on the swingarm. A rear wheel aperture is configured to receive a rear wheel at a rear end of the swingarm. The system also has a shock absorber having a top portion connected to the top shock mount, and a bottom portion connected to the bottom shock mount.

In an embodiment, the rear portion is a seat tube configured to adjustably receive a seat. Further, the top portion of the shock absorber is pivotally connected to the top shock mount, and the bottom portion of the shock absorber is pivotally connected to the bottom shock mount.

In an embodiment, the wheel aperture is positioned on a dropout portion. Preferentially, the dropout portion is integrally molded to the rear portion of the swingarm.

To decrease leverage as well as prevent lateral forces exerted on the frame, the rear wheel aperture and swingarm pivot are positioned above the bottom shock mount.

In yet another aspect of the present invention, the bicycle having a rear suspension system is comprised of a frame member having a front portion, a rear portion, and a top portion. The top rear portion has a top shock mount configured to receive a top portion of a shock absorber. A swingarm pivotally connected to the frame via a swingarm pivot, wherein a bottom shock mount is positioned on the swingarm. The swingarm also has a wheel aperture configured to receive a rear wheel. A shock absorber having a top portion pivotally connects to the top shock mount, and a bottom portion pivotally connects to the bottom shock mount. The swingarm pivot and the rear wheel aperture are positioned above the bottom shock mount such that the shock absorber is configured to substantially decrease leverage.

Further features and advantages of the invention will appear more clearly on a reading of the following detail description of the preferred embodiment of the invention, which is given by way of non-limiting example only and with reference to the accompanying drawings.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a front elevation view of an exemplary bicycle having the rear suspension system integrated therein, according to an embodiment of the present invention;

FIG. 2 illustrates a front elevation view of the bicycle suspension system having the shock absorber mounted to the frame, according to an embodiment of the present invention;

FIG. 3 illustrates a front elevation view of the bicycle suspension system having a diagram defining the spatial relation of the shock mount with the bicycle components, according to an embodiment of the present invention; and

FIG. 4 illustrates a front elevation view of the exemplary bicycle having a diagram defining the spatial relation of the shock mount with the bicycle components, according to an embodiment of the present invention.

### DETAILED DESCRIPTION

The specific details of the single embodiment or variety of embodiments described herein are set forth in this application. Any specific details of the embodiments are used for demonstration purposes only and no unnecessary limitation or inferences are to be understood therefrom.

Any reference to “invention” within this document is a reference to an embodiment of a family of inventions, with no single embodiment including features that are necessarily included in all embodiments, unless otherwise stated. Furthermore, although there may be references to “advantage's” provided by some embodiments, other embodiments may not include those same advantages, or may include different advantages. Any advantages described herein are not to be construed as limiting to any of the claims.

Before describing in detail exemplary embodiments, it is noted that the embodiments reside primarily in combinations of components related to the system. Accordingly, the system and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

Specific quantities, dimensions, spatial characteristics, compositional characteristics and performance characteristics may be used explicitly or implicitly herein, but such specific quantities are presented as examples only and are approximate values unless otherwise indicated. Discussions and depictions pertaining to these, if present, are presented as examples only and do not limit the applicability of other characteristics, unless otherwise indicated.

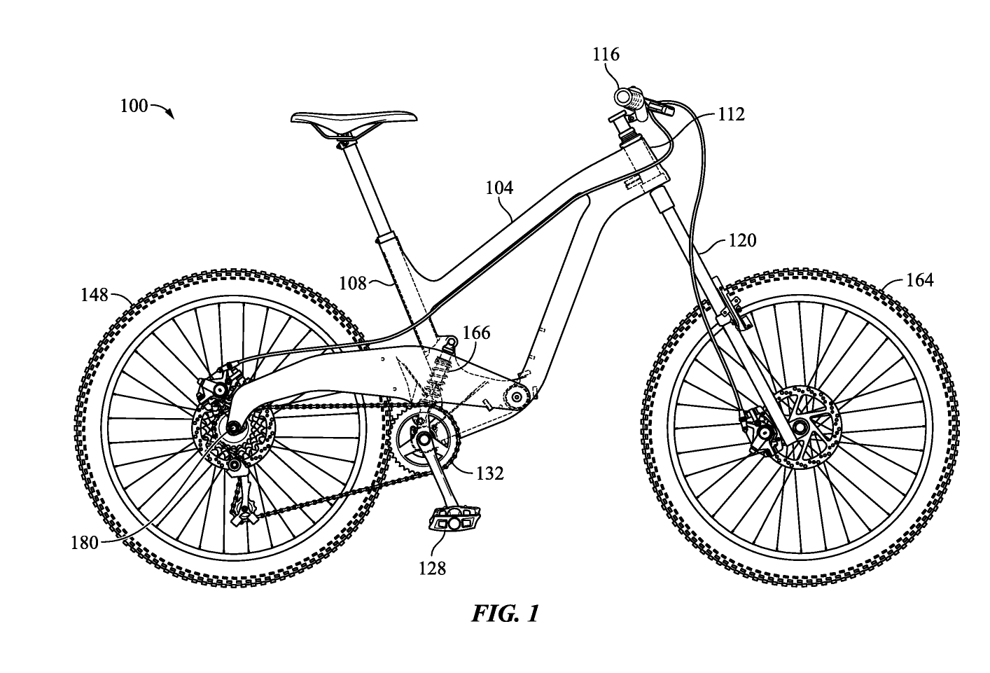

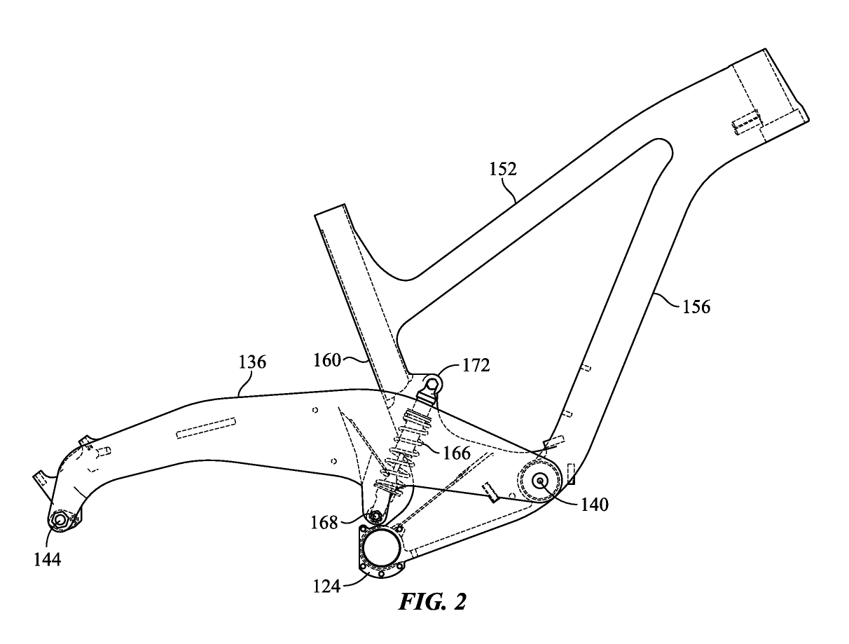

Referring now to the drawings wherein like reference numerals designate identical or corresponding parts throughout the views, a bicycle 100 is illustrated in FIGS. 1-2 having a main frame 104. The main frame 104 generally includes a seat post member 108 and head tube mount 112 which may be integrally molded, welded, or by other means secured together to comprise the main frame 104. The head tube mount region 112 is configured to receive the handle post 116 and front fork assembly 120 as commonly known in the arts. A bottom bracket 124 is configured to receive the pedal 128 and crank assemblies 132. A swingarm 136 extends from a swingarm pivot 140 and extends to the rear wheel axle aperture 144 wherein the rear wheel assembly 148 is rotatably affixed. Although the bicycle 100 typically includes all of the foregoing members and components, alternative embodiments can have more or less than all of the foregoing members, and can include them in various forms, sizes, and configurations, and still achieve the intended functionality and beneficial aspects of the invention.

Typically, the main frame 104 component is comprised of a substantially triangular member, having a top portion 152, front portion 156, and rear portion 160. The front portion 156 is positioned near most the front wheel 164 extending between the headtube 112 and swing arm pivot region 140. The top portion 152 extends from the head tube 112 above the front portion 156 to the seat tube 108. The rear portion 160 extends substantially downward from the seat tube 108 to the bottom bracket 124 and swingarm pivot region 140. In this manner, the head tube 112, seat tube 108, and bottom bracket 124 are supported relative to each other by the rigid main frame 104.

The head tube 112, supports the front fork 120 on which the front wheel 164 is attached while also supporting the handlebar components 116 used for steering the bicycle during use. The seat tube 108 is utilized for adjustably supporting the seat. The bottom bracket 124 supports the pedals 128 and chain drive mechanism 132 for powering the bicycle.

In reference to FIG. 2, the novel single-pivot rear suspension system for a bicycle is illustrated in a preferred embodiment of the present invention. The frame 104 includes a swing arm pivot 140 whereabout the swing arm may pivot at a single point during use. The swing arm pivot 140 is positioned forward and slightly above the bottom bracket 124 as shown at L₁. This configuration positions the swing arm pivot point above the shock absorber 166 bottom eyelet 167. A rear wheel aperture 144 is positioned at an aft end 188 of the swing arm 136 which is configured to receive the rear wheel 148 which is above the lower shock mount 168 as shown in L₂. This configuration, along with the shock mounts 168, 170 on the frame positions the lower shock mount 168 below a lateral line L₃ between the swing arm pivot 140 and the rear wheel mounting aperture 144. This configuration decreases the leverage ratio in the available space by placing the shock at the swing arm pivot 140 point rather than above it.

The swing arm 136 is an elongated member pivotally connected the frame 104 extending between the swing arm pivot point 140 rearwardly to the rear axle 176. The rear wheel mounting aperture 148 is positioned on a rear wheel dropout member 180 to preferentially align the rear wheel axle 176 with the swing arm pivot 140. The swingarm 136 is an angled member having a forward portion 184 which extends from the swing arm pivot 140 on the frame 104 upwardly and rearwardly, and a rear portion 188 which extends from the top of the forward portion 184 rearwardly to the rear axle 176 and wheel mount aperture 144. The configuration of the swing arm and its interaction with the shock absorber and mounting points permit the rear suspension system to favorably operate without the use of a linking member as used in the prior art.

In an embodiment, the there are two swing arms positioned on each the right and left sides of the bicycle as commonly known in the arts.

A shock absorber 166 controls the motion of the swingarm 136 relative to the bicycle frame members and thereby controlling the motion of the rear wheel. Typically, the shock absorber consists of two telescoping tubes which slide into each other and a spring, or spring-like mechanism. Each end of the shock absorber has a mounting component, which typically takes the form of at least one aperture permitting the shock absorber to be mounted to the frame 104. A bearing may be positioned within each aperture permitting the shock to pivot smoothly when the suspension is active. While every shock includes a form of spring mechanism, many devices known in the arts may be used. A damping system, which regulates the rate at which the spring compresses and rebounds may also be utilized. One skilled in the arts may appreciate that an undamped shock may be utilized, however, these are typically featured on inexpensive and low performance shocks as they result in undesired shock characteristics.

A top shock mount 172 is affixed to the rear portion 160 of the main frame 104 at a point on the interior perimeter 190. The bottom shock mount 168 is affixed above the bottom bracket 124 at a position below line L₃ as described above. The first end of the shock absorber 167 is pivotally connected to the top shock mount 172 while the second end of the shock absorber is pivotally connected to the bottom shock mount 168. This positions the top shock mount 172 in front of the axis defined by the seat tube 108, while the bottom shock mount 168 is positioned behind the axis defined by the seat tube 108. When compressed and expanded, the shock absorber 166 travels along path T₁. When the user encounters an obstacle such as a rock, the shock compresses along travel path T₁ permitting the swing arm 136 to rotate about the pivot point 140 and absorb the impact of the object.

One skilled in the art may appreciate that either an air or coil-based shock may be utilized in the present invention.

In a preferred embodiment, the shock absorber 166 has a top 167 and bottom end 169 each having an aperture configured to receive a pivot pin 192 therethrough. The top end 167 is secured to the frame at the upper shock mount 172.

A feature of the invention is that the shock absorber 166 is engaged with the main frame of the bicycle at one end. This differs from designs utilizing a link as in these configurations, the shock is not directly affixed to the frame of the bicycle. The present invention limits the force during use to two directions. The higher the forces the suspension and bicycle encounter during use amplifies the strength of forces in the two directions. Existing link designs result in an increase of deflection forces outside of the bidirectional range that is preferred.

In an embodiment, the rear wheel suspension system may include a pair of seat stays and a pair of chain stays. Typically, seat stays, and chain stays are joined together at their rearward ends proximate the rear wheel axle. Pairs are configured having corresponding members on either side of the rear wheel. Size, orientation, and configurations of the seat stays, and chain stays may vary based on the size of the bicycle frame and the size of the rear wheel.

The frame 10 may be configured as a number of common shapes utilized in the cycling industry dependent upon the terrain application and specialization of the rider.

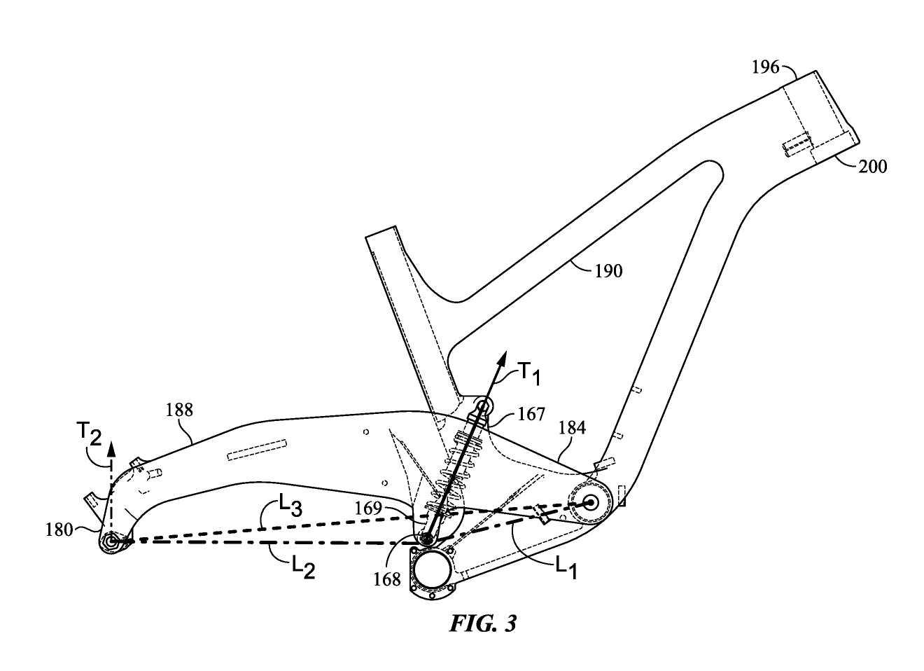

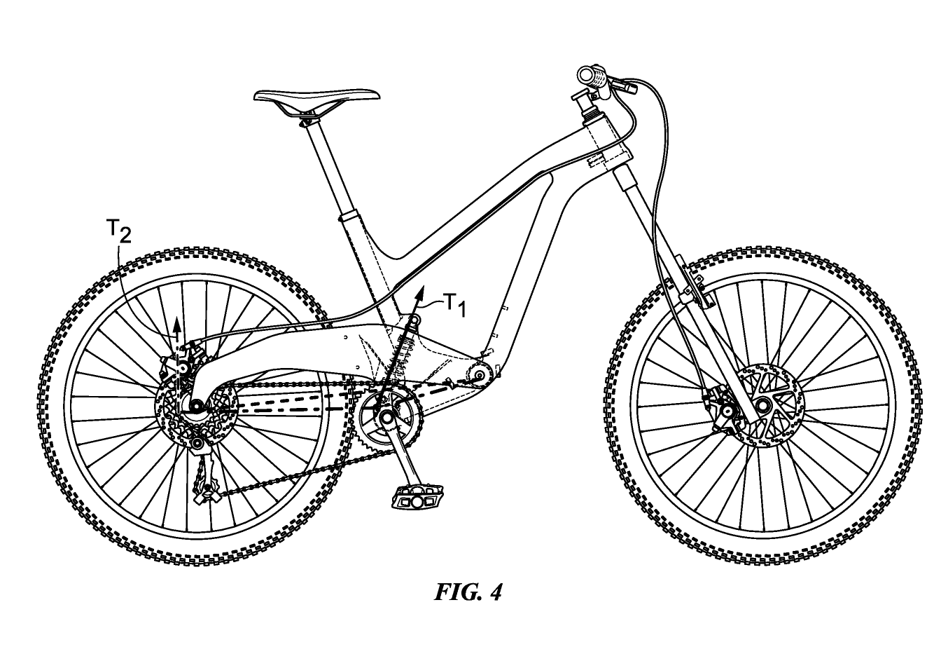

FIGS. 3 and 4 illustrate a bicycle having a preferential rear suspension system, according to an embodiment of the present invention. While the rear suspension system of the present invention may be implemented on numerous bicycle configurations and sizes, the present embodiment illustrates one such variation of current configurations in the art. The frame components 104 has a head tube 112 receiving the handle bar assembly 116 extending from a top portion 200 of the head tube. The front fork assembly 120 extends from the bottom portion 200 of the head tube region 112. The front fork assembly 120 may be comprised of suspension components commonly used in the arts. The front fork assembly is affixed to the front wheel components 164. In particular embodiments, a front brake system 204 may be incorporated into the front wheel mechanism.

Additional bicycle components include a rear wheel, pedals, and seat which each may include their respective components in concurrence with systems commonly utilized in the arts.

It can be understood by one skilled in the art that a multitude of front suspension, head tube, front wheel and brake systems may be incorporated without differing from the present invention related to the rear suspension system of the bicycle.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A bicycle having a rear suspension system comprising:
a shock absorber having a top end and a bottom end wherein the top end is pivotally connected to a top shock mount, and wherein the bottom end is pivotally connected to a bottom shock mount,
a bicycle having a frame, wherein both the top shock mount is disposed on a frame of a bicycle, and the bottom shock mount is disposed on a swingarm of the bicycle, and wherein the swingarm is pivotally mounted to the frame.

2. The system of claim 1, wherein the frame further comprises:
a top portion;
a front portion; and
a rear portion.

3. The system of claim 2, wherein the swingarm is pivotally mounted to the frame via a swingarm pivot.

4. The system of claim 3, having the top shock mount positioned on the rear portion.

5. The system of claim 4, wherein the swingarm is further comprised of a rear wheel aperture configured to receive a plurality of rear wheel components.

6. The system of claim 5, wherein the rear wheel aperture and the swingarm pivot are positioned above the bottom shock mount.

7. The system of claim 6, wherein the shock absorber is configured to decrease leverage.

8. The system of claim 1, wherein the frame further comprises a headtube, wherein the headtube is configured to receive handlebars and a steering fork assembly.

9. A bicycle having a rear suspension system comprising:
a frame member having a front portion, a rear portion, and a top portion, the top rear portion having a top shock mount;
a swing arm pivotally connected to the frame, wherein a bottom shock mount is positioned on the swingarm, and having a wheel aperture configured to receive a rear wheel;
a shock absorber having a top portion connected to the top shock mount, and a bottom portion connected to the bottom shock mount;

10. The system of claim 9, wherein the rear portion is a seat tube configured to adjustably receive a seat.

11. The system of claim 9, wherein the top portion of the shock absorber is pivotally connected to the top shock mount, and wherein the bottom portion of the shock absorber is pivotally connected to the bottom shock mount.

12. The system of claim 9, wherein the wheel aperture is positioned on a dropout portion, wherein the dropout portion is integrally molded to the rear portion of the swingarm.

13. The system of claim 12, wherein the wheel aperture and swing arm pivot are positioned above the bottom shock mount.

14. The system of claim 13, wherein the shock absorber is configured to decrease leverage.

15. The system of claim 14, wherein the shock absorber substantially prevents lateral forces exerted on the frame.

16. A bicycle having a rear suspension system comprising:
a frame member having a front portion, a rear portion, and a top portion, the top rear portion having a top shock mount configured to receive a top portion of a shock absorber;
a swing arm pivotally connected to the frame via a swingarm pivot, wherein a bottom shock mount is positioned on the swingarm, and having a wheel aperture configured to receive a rear wheel;
a shock absorber having a top portion connected to the top shock mount, and a bottom portion connected to the bottom shock mount,
wherein the swingarm pivot and the rear wheel aperture are positioned above the bottom shock mount, wherein the shock absorber is configured to substantially decrease leverage.

17. The system of claim 15, wherein the rear portion is a seat tube configured to adjustably receive a seat.

18. The system of claim 15, wherein the top portion of the shock absorber is pivotally connected to the top shock mount, and wherein the bottom portion of the shock absorber is pivotally connected to the bottom shock mount.

19. The system of claim 15, wherein the wheel aperture is positioned on a dropout portion, wherein the dropout portion is integrally molded to the rear portion of the swingarm.

20. The system of claim 15, wherein the frame further comprises a headtube, wherein the headtube is configured to receive handlebars and a steering fork assembly.
